(19) United States
(12) Patent Application Publication
(10) Pub. No.: US 2005/0072448 A1
(43) Pub. Date: Apr. 7, 2005

(54) Device and method for cleaning chain

(76) Inventors: Enrique L. Kilayko, Stuart, FL (US); Liam A. Ryan, Ardnacrusha (IE)

Correspondence Address: MCCRACKEN & FRANK LLP, 200 W. ADAMS STREET, SUITE 2150, CHICAGO, IL, 60606, US

(21) Appl. No.: 10/680,645

(22) Filed: Oct. 7, 2003

(51) Int. Cl. B08B 7/00

(52) U.S. Cl. 134/6; 15/256.6

(57) ABSTRACT

A device and method to remove debris from marine chains such as anchor chains includes a control circuit, a housing through which a chain can pass, an electromagnet within the housing, and a cleaning medium to remove debris from the chain, the electromagnet and the cleaning medium cooperating to remove the debris.

### TECHNICAL FIELD

The present invention relates to a device and a method for cleaning chain. More particularly, this invention relates to a device and a method of cleaning anchor chain in a marine environment.

### BACKGROUND OF THE INVENTION

Chains used in a marine environment, particularly anchor chains can become fouled by debris such as seaweed, mud, slime, algae and similar foulants. While these materials that foul the anchor chain can be annoying, these materials can also foul the deck, the chain windlass, the chain lockers, and the boat hull. At the minimum, this fouling necessitates cleaning these surfaces. At the worst, the fouling can cause equipment to malfunction by overloading the motors used to lift the anchor out of the water, fouling of the windlass, rollers and the like that lift and guide the chain.

Most prior devices to clean anchor and other marine chains relied solely on mechanical abrasion for their cleaning effect. An example is U.S. Pat. No. 5,351,359 that discloses an anchor chain cleaning brush device. This device relies solely on the abrasive action of the brush bristles to clean the chain.

### SUMMARY OF THE INVENTION

One aspect of the present invention relates to a device for removing debris from a chain that includes a control circuit; a housing defining an aperture passing through the housing, the aperture having a size such that a chain can pass through the housing; an electromagnet located within the housing electrically connected to the control circuit; and a cleaning medium within the housing in proximity to the aperture. The control circuit energizes the electromagnet in a series of discrete pulses to assist the cleaning medium in removing debris from the chain.

A further aspect of the present invention relates to a method for the removal of debris from a chain that includes the steps of passing the chain through a housing wherein the housing includes an electromagnet and a cleaning medium; energizing the electromagnet in a pulsed fashion as the chain passes through the housing; and contacting the chain with the cleaning medium.

### BRIEF DESCRIPTION OF THE DRAWINGS

FIG. 1 is a view of one embodiment of a device of the present invention showing the device in use on a boat anchor chain;

FIG.2 is a plan view of a control unit for one embodiment of the present invention;

FIG. 3 is a plan view of one embodiment of the cleaning device of the present invention;

FIG. 4 is a view taken along line 4-4 in FIG. 3;

FIG. 5 is a flow diagram of a main program of one embodiment of the present invention;

FIGS. 6A and 6B are a flow diagram of the interrupt program of one embodiment of the present invention;

FIG. 7 is a schematic view of the circuit of one embodiment of the present invention;

FIGS. 7A-C are detailed circuit diagrams of one embodiment of the circuit shown in FIG. 7;

FIG. 8 is a plan view of another embodiment of the present invention;

FIG. 9 is a view taken along line 9-9 in FIG. 8; and

FIG. 10 is a plan view of another embodiment of a control unit of the present invention.

### DETAILED DESCRIPTION OF THE PREFERRED EMBODIMENTS

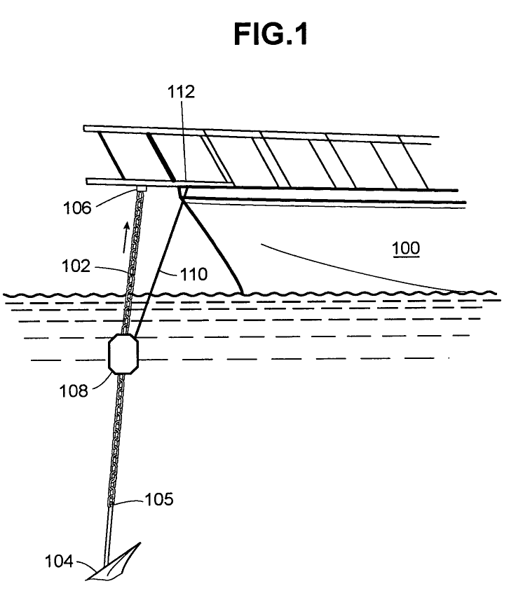

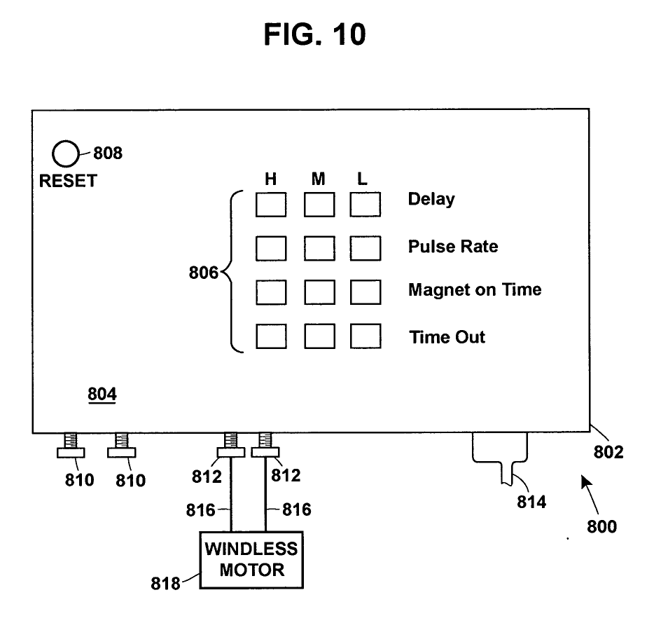

Referring to FIG. 1, a boat 100 has an anchor chain 102 connected to an anchor 104 by a shackle 105. The anchor chain 102 passes over bow roller 106 and the anchor chain 102 is raised and lowered by a chain windlass (not shown) that can be powered by an electric motor 818 (FIG. 10), can be hand operated, or can be a free fall type of windlass where the weight of the anchor 104 lowers the chain 102 when the windlass is unlocked. The anchor chain 102 passes through a chain cleaning device 108. The chain cleaning device 108 is powered by a cable 110. The cable 110 not only provides power to the chain cleaning device 108 but the cable 110 also secures the chain cleaning device 108 to the boat 100 so that the chain cleaning device 108 stays no more than 4 feet under the water when the anchor 104 has been deployed. The cable is secured to the boat 100 by a suitable conventional fitting 112. The shape of the chain cleaning device 108 allows the chain cleaning device 108 to pass over the bow roller 106 as the anchor 104 is lifted. The chain cleaning device 108 stays submerged and the chain 102 passes through the chain cleaning device 108 as the anchor 104 is lifted. Only when the anchor 104 or the shackle 105 contacts the chain cleaning device 108 is the chain cleaning device 108 lifted out of the water.

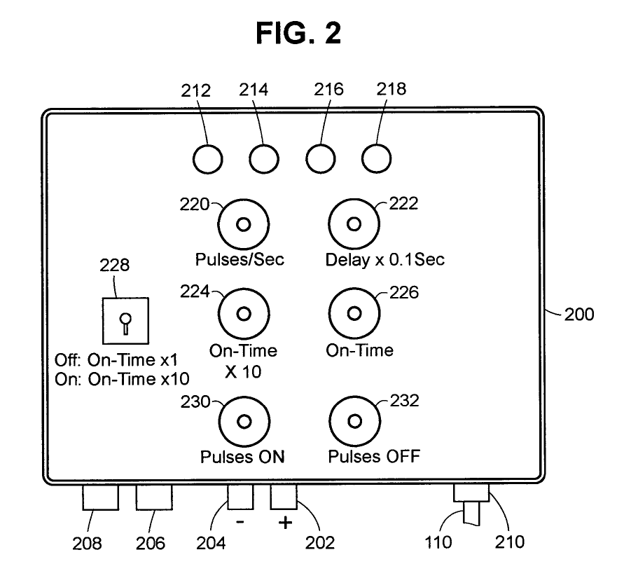

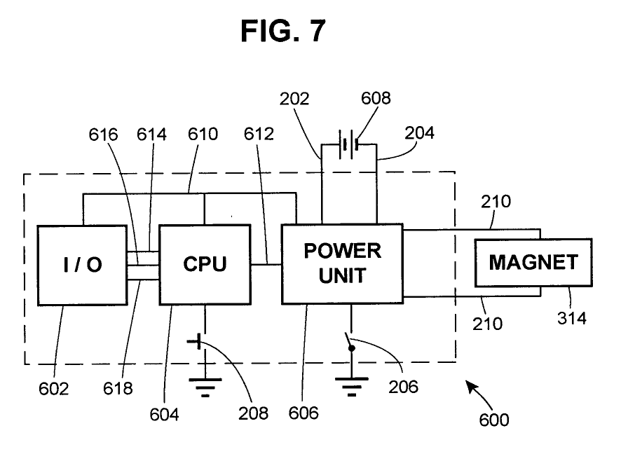

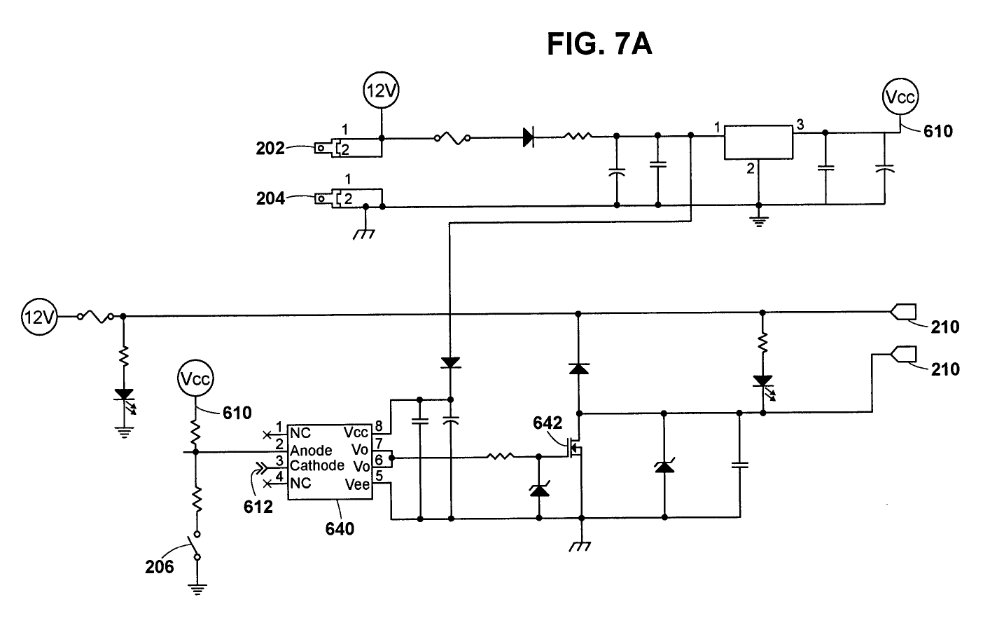

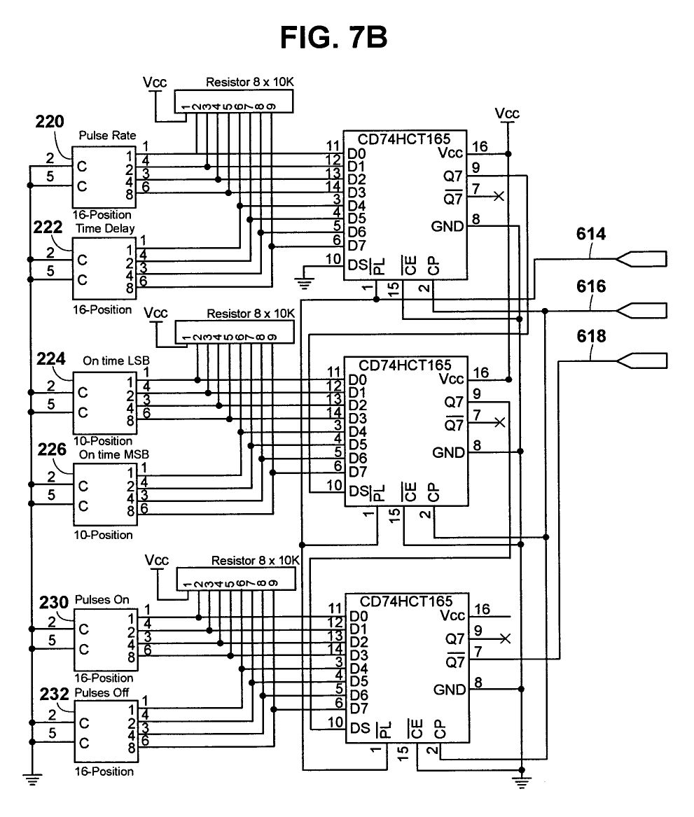

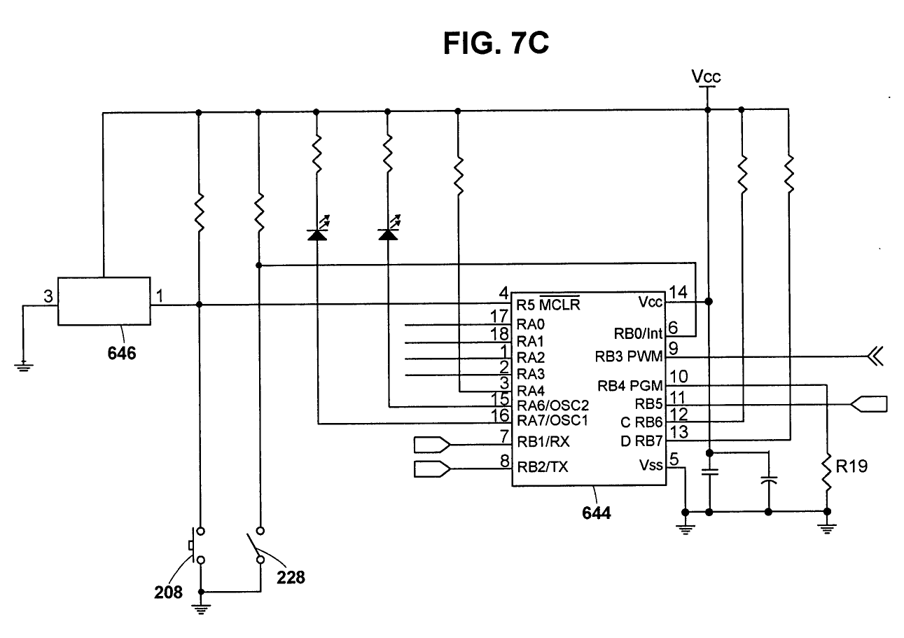

FIG. 2 shows a control unit 200 for the chain cleaning device 108. The control unit 200 includes battery connectors 202 and 204 to enable the control unit 200 to be powered by a battery 608 (FIG. 7) that also may power some or all the accessories for the boat 100. The battery 608 will provide either 12 volt or 24 volt power to the control unit 200 through the battery connectors 202 and 204. The control unit 200 also includes a switch 206 that starts and stops the power to chain cleaning device 108. The switch 206 can be a simple off/on switch or can be a conventional switching circuit that senses the operation of the electric motor 818 that powers the chain windlass. In addition, the control unit 200 also includes a reset switch 208. This reset switch 208 enables the control unit 200 to be reinitialized as will be discussed hereinafter. The control unit 200 has a connector 210 to enable the cable 110 to be connected to the control unit 200. At the top of the control unit 200 are a series of light emitting diodes (LEDs) 212, 214, 216, and 216. These LEDs 212, 214, 216, and 218 can indicate any of a number of status conditions for the control unit 200. For instance, the LEDs can indicate that the control unit 200 has been powered on, that the control unit 200 is sending power to pulse the chain cleaning device, that the control unit has been reset and is reinitializing, and the like. The control unit 200 also has a hex rotary switch 220 that provides values 0-F (16 increments) to the control circuit as discussed hereinafter. The switch 220 controls the rate at which the control unit 200 sends pulses of power to the chain cleaning device 108. In the embodiment as shown in FIG. 7, the switch 220 enables the chain cleaning unit 108 to operate at between 0 and 15 pulses per second. A typical range is from about 2 to about 8 however, the exact rate of pulsing can vary depending on the local conditions. A similar rotary switch 222 controls the start up delay of the chain cleaning device 108. The control unit 200 delays the start of the chain cleaning device 108 for a short period after the start of the anchor windlass motor 818. This keeps from overloading the circuits on the boat 100. The switch 222 can delay the start of the chain cleaning device 108 by from 0 to 1.5 seconds. Typical delay times are between 0.2 to 0.4 seconds. Similar switches 224 and 226 control the on time or length of each pulse for the chain cleaning device 108. The switch 224 controls the length of the pulse to 0.01 second per increment and the switch 226 controls the length of the pulse to 0.001 second per increment. In addition an off/on switch 228 adds a multiplier of 10 to the combined value from switches 224 and 226 when the switch 228 is on and no multiplier when the switch 228 is off. The combination of the positions for the switches 224, 226, and 228 enable control of the pulse length from 0 to 0.99 seconds. Typical values range between about 0.1 to 0.2 seconds. Switches 230 and 232 control the number of on pulses in each cycle and the number of off or skipped pulses in each cycle. While the control unit 200 is capable of from 0 to 15 on pulses in each cycle and from 0 to 15 off or skipped pulses in each cycle, the practical values are 4 to 6 on pulses for each cycle followed by 0 to 2 skipped pulses for each cycle.

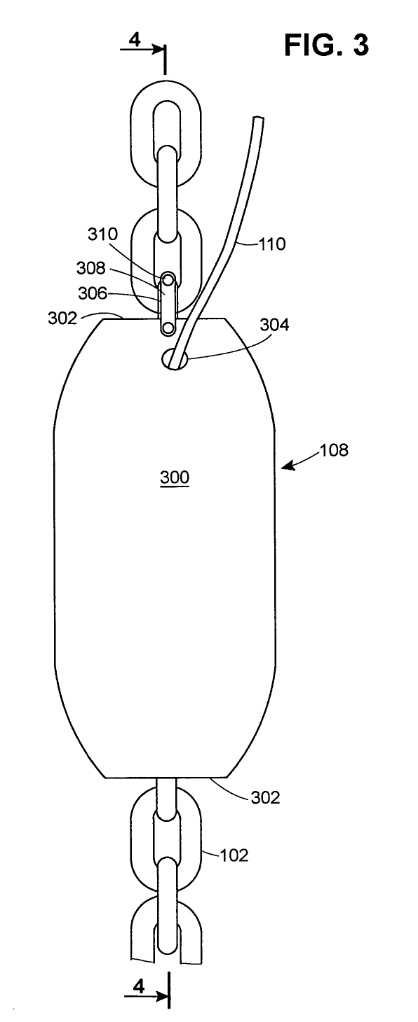

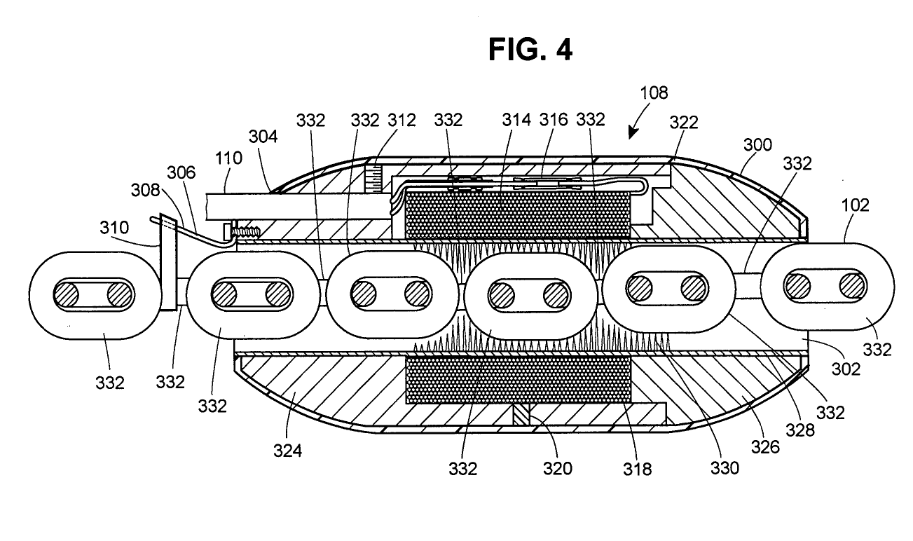

Referring to FIGS. 3 and 4, the chain cleaning device 108 includes a housing 300 that has a passage 302 extending through the housing 300. The passage 302 is sized such that typical chains 102 used for small boat anchors can easily fit through the passage 302. Typical chains 102 have a diameter of from between 0.3 to 0.4 inches and a link width of from about 1 to about 1.4 inches and these typical chains 102 are formed from a series of links 332 made from a material that can be magnetized such as mild steel, galvanized steel, and hardened steel. The passage 302 is therefore about 1.25 to about 1.75 inches in diameter The cable 110 enters the housing 300 through an opening 304. The cable 110 is held in place by a set screw 312 that secures the cable 110 to the housing 300. The connection between the housing 300 and the cable 110 must be sufficiently strong so that the cable can support the chain cleaning device 108 at a desired level below the surface of the water. The distance the chain cleaning device 108 is held below the water is controlled by the length of the cable 110 from the fitting 112 to the chain cleaning device 108. Typically, the chain cleaning device 108 is held by the cable 110 between about 2 to about 4 feet below the water surface when the anchor 104 has been deployed and is holding the boat 100 in position. The chain cleaning device 108 will ride up with the anchor 104 when the anchor 104 is raised, and the chain cleaning device 108 will pass over the bow roller 106 to lay on the deck (not shown) of the boat 100. In order to move the chain cleaning device off the deck and over the bow roller 106 when the anchor 104 is lowered, the chain cleaning device preferably includes a chain engaging device 306 composed of spring member 308 and engaging pin 310. The spring member 308 is sufficiently flexible such that the engaging member 310 can be manually inserted into the chain links 332 and the engaging member 310 will hold the chain cleaning device in place on the chain 102 as the anchor chain is being lowered. As soon as the housing 300 goes over the bow roller 106 the weight of the cleaning device 108 will allow the spring member 308 to pull the engaging pin 310 away from the chain link 332 and the chain cleaning device 108 will fall until the chain cleaning device either reaches the anchor 104 or the shackle 105 or until the chain cleaning device 108 reaches the limit of the cable 110. If the windlass is reversed before the housing 300 has gone over the bow roller 106, the spring member 308 will move the engaging member 310 out of contact with the chain link 332 and the engaging pin 310 will have to be re-inserted into the chain link 332.

The cable 110 is electrically connected to an electromagnetic coil 314 by conventional connectors 316. The connectors 316 are sealed within an encapsulant 318 to seal a distal portion 318 of the cable 110, and the connectors 316 from the effects of the water into which the chain cleaning device 108 will be placed in use. The encapsulant 318 can be injected into the housing 300 through an opening 320 that is self sealed by the encapsulant 318. Suitable encapsulants 318 for use in the devices of the present invention include conventional electric encapsulants such as epoxy compounds, potting compounds, and the like.

The coil 314 can be any conventional electromagnetic coil capable of operating on the voltages and currents typically found in boat accessory electrical systems, such as either 12 volt or 24 volt systems. A typical 12 volt system will operate at from between about 15 to 50 amperes and a 24 volt system will operate at between 7.5 and 25 amperes. The coil 314 will typically have a magnetic flux sufficiently large to attract the chain links 332 to the chain cleaning device 108. The coil bobbin or the internal diameter to the coil should be large enough to hold and retain a series of cleaning elements 330 in place and also large enough so that the chain 102 can pass through the chain cleaning device 108. Typical 12 volt coils 314 are wound around a ferrous or a non-ferrous bobbin and have between about 200 to about 450 turns of AWG wire gauge 13 through 14.5 (0.0739 inches to 0.0624 inches in diameter). A typical 24 volt coil 314 will have between about 475 to about 900 turns of AWG wire gauge 16 through 17.5 (0.0524 inches to 0.0444 inches in diameter).

The housing 300 includes an outer thermoplastic or a thermoset shell 322, a proximal housing portion 324 and a distal housing portion 326. The proximal housing portion 324 and the distal housing portion 326 are formed from any suitable material such as ferrous metal that can extend the magnetic field created by the coil 314. As shown in FIG. 3., the proximal housing 324 and the distal housing 326 are tapered in shape. This shape enables the chain cleaning device 108 to more easily pass over the bow roller 106 during the raising and lowering of the anchor 104. The interior surface of the passage 302 is lined with an interior sleeve 328. The sleeve 328 can be either magnetic or non-magnetic material such as stainless steel. Since the sleeve 328 is relatively thin, the magnetic properties of the sleeve 328 do not seem to have any impact on the performance of the chain cleaning device 108. The sleeve 328 also supports the series of cleaning elements 330. Suitable materials useful as the cleaning elements 330 include natural bristles and thermoplastic bristles, such as nylon bristles, polypropylene bristles, and polyethylene bristles, abrasive surfaces, and the like. The cleaning elements 330 should extend sufficiently far into the passage 302 so as to contact as much of the surface of the chain 102 as possible, but at the same time the cleaning elements 330 should be flexible enough so that the chain 102 can readily pass through the chain cleaning device 108. The cleaning elements 330 can extend radially around the entire periphery of the passage 302 and also can extend longitudinally along the sleeve 328. It is preferred that the cleaning elements 300 extend for a significant portion of the length of the passage 302. Typically, the cleaning elements 330 can be held in place within the chain cleaning device 108 by a friction fit or alternatively can be fastened in place by any conventional fastening means.

When the circuit within the control unit 200 energizes the coil 314, the proximal and distal portions of the housing 324 and 326 become magnetic. This magnetic force attracts some or all of the links 332 of the chain 102 toward the side of the sleeve 328 closest to the coil 314. It is believed that this magnetic attraction assists cleaning of the chain 102 by forcing the links 332 into closer contact with the abrasive elements 330 and also rocking or wiggling the chain cleaning device 108 as the chain 102 passes through the passage 302.

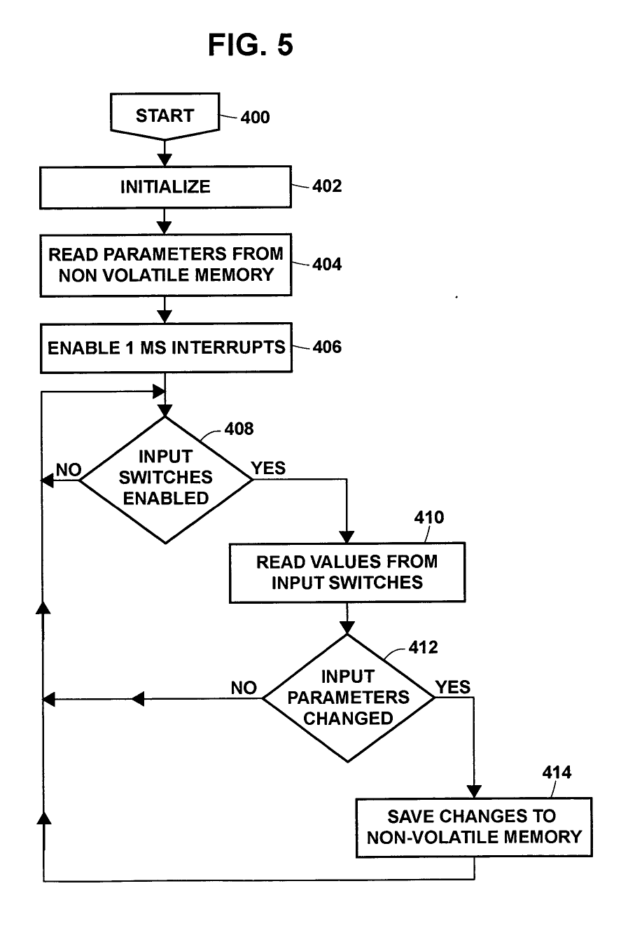

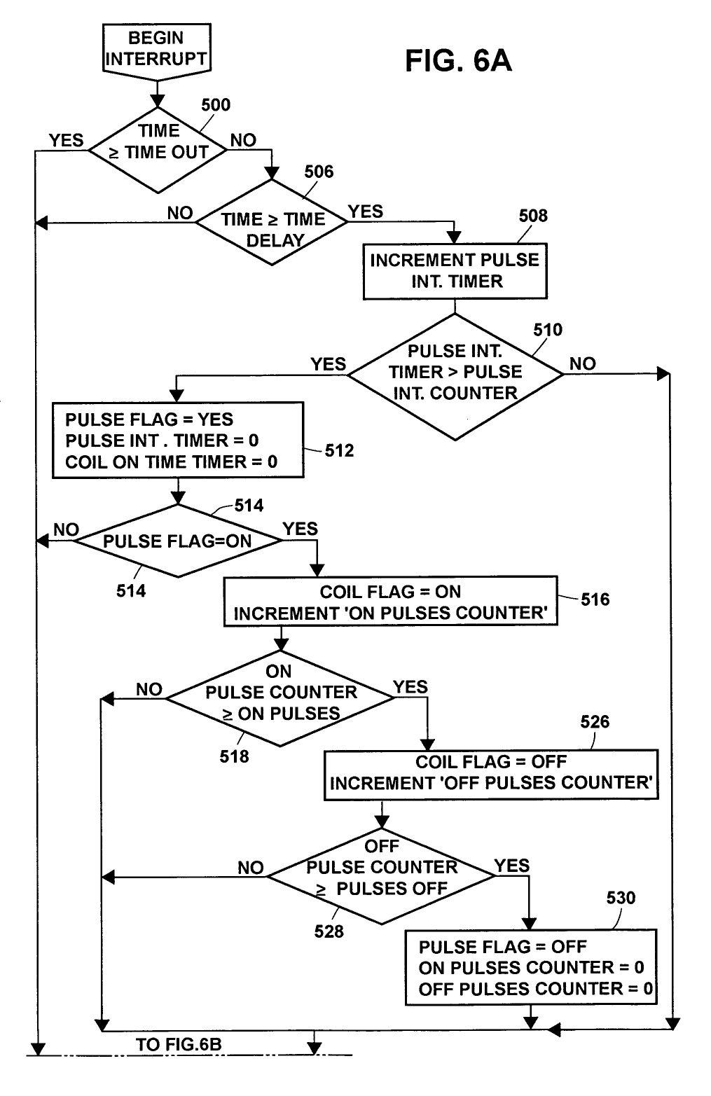

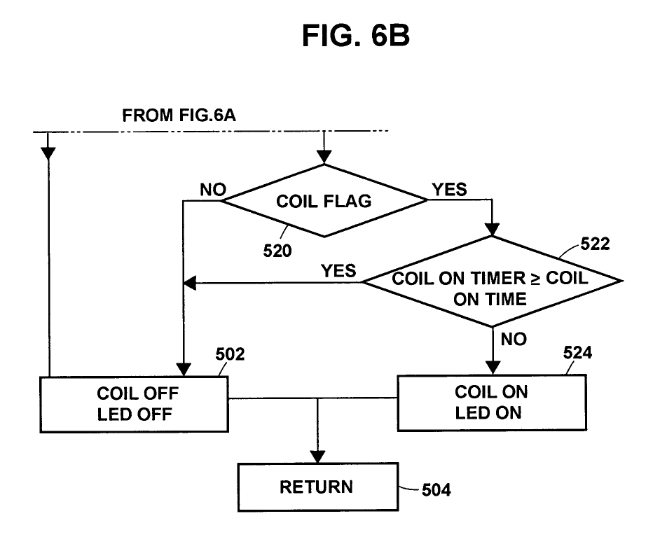

Referring to FIG. 5, the control program begins at a block 400 and control then passes to a block 402 that initializes the microprocessor and performs a self test on the system and microprocessor. If the self test fails, the program terminates with an error message to the user. This can be in the form of a flashing LED or other method of communicating a system fault to the user as are well known in the art. If the block 402 performs a successful initialization, control then passes to a block 404 that reads the stored system parameters from the memory of the microprocessor. For instance, the microprocessor can have an eeprom or electrically erasable programmable read only memory or a flash eeprom. The memory is both erasable and programmable and holds the values for the system even when the system has been powered down. After the program has read the parameters from the eeprom, control then passes to a block 406 that enables the interrupt routine more fully discussed with regard to FIGS. 6A, 6B. The interrupt routine will run every 1 ms or other selected time interval until the system has been powered down or until the time out value has been reached. Control then passes to a block 408 that detects if any of the input switches have been enabled. If no changes to the input switches have been detected the program will take the No branch and continue to test for changes. Meanwhile, the interrupt routine of FIGS. 6A, 6B will continue to execute every time the interrupt time interval has passed. If there has been a change to any of the switch values, the block 408 will pass control on the Yes branch to a block 410 to read the values that have been input on the switches. Control then passes to a block 412 that determines if any of the values that have been input using the input switches or other input devices have changed any of the values for any of the parameters. If any values have changed, the block 412 will branch on the Yes branch to a block 414 that writes the new values to the memory in the microprocessor. If no values have changed, the block 412 will branch back to the block 408 on the No branch. The program continues on this main loop and at the same time executes the interrupt program that will be described below relative to FIG.6 at each increment of time set by the interrupt value. The program as set forth in FIG. 5 will only terminate when the control unit has been switched off or powered down.

Referring to FIGS. 6A and 6B, the interrupt routine that is enabled by the block 406 will execute every time the interrupt interval, such as 1 ms, has elapsed. The interrupt routine begins at a block 500 that tests to determine if the elapsed time since program initiation is greater than or equal to the preset time out value. The time out value can be a value that is preset at the factory or it can be a value that can be modified by the user. In any event, for each time the program is run, there will be a specific time out value. The value should be set to a time that is longer than the time to raise an anchor in a typical small craft environment. Values for the time out between 3 and 6 minutes have been found to be acceptable. If the block 500 determines that the elapsed time is greater than or equal to the time out value, then the control will pass directly to a block 502 that turns the electromagnet coil off and for the control unit as shown in FIG. 2 switches off the “Coil On” LED. Control then passes to a block 504 that ends the interrupt routine and returns control to the main program described in FIG. 5.

If the block 500 determines that the elapsed time is less than the time out value, then control passes on the no branch to a block 506 that tests to see if the elapsed time is greater than or equal to the time delay value. The time delay value can be set, as noted above with regard to FIG. 2, by setting a value using the switch 222. Alternatively, the time delay value can be preset at the factory to provide an average time delay that is applicable for most normal situations. Alternatively, as will be discussed below relative to FIG. 10, the user can chose this value from a small number of preset values. In any event if the elapsed time is not less than the time delay value, control passes on the No branch to the block 502 that operates as noted above. If the elapsed time is greater than or equal to the time delay value, control then passes by the Yes branch to a block 508 that increments a pulse interval timer by a specified value, usually 1. Control will then pass to a block 510 that tests to determine if the pulse interval timer value is greater than or equal to the pulse interval. If the test by the block 510 is positive, then control will pass by the Yes branch to a block 512 that resets the pulse flag to 0, the pulse interval timer value to 0 and the coil on timer value to 0. Control then passes to a block 514, that determines if the pulse flag is set to on. If the pulse flag has not been set, the control will pass on the No branch to the block 502 and the program will proceed as described above. If the pulse flag has been set, then control will pass by the Yes branch to a block 516 that sets the coil flag to on and increments an on pulses counter by a specified value, usually by 1. Next a block 518 then checks to see if the on pulses counter is greater than or equal to the predetermined number of pulses that has been set in the input parameters. If the on pulses counter is not greater than the predetermined value, then control passes by the No branch to a block 520 that determines the state of the coil flag. If the block 520 determines the coil flag is set to yes, then control will pass via the yes branch to a block 522 that test to determine if the coil on timer value is greater than or equal to the coil on time. If this test is true, the time is greater than or equal to the time on value, control will pass by the Yes branch to the block 502 and the program will proceed as described above. If this test is not true, the time is less than the time on value, control will pass by the No branch to a block 524 that switches the coil power on and switches on the Coil On LED. Control then passes to the block 504 that returns control to the main program. Referring back to the block 510, if the test of the block 510 is not true, the pulse interval timer is not greater than or equal to the pulse interval, control will pass via the No branch to the block 520 and the program will proceed as described above.

If the block 518 determines that the on pulses counter is greater than or equal to the preset number of on pulses, then control will pass by the Yes branch to a block 526 that will set the coil flag to off and increment an off pulses counter by a preset value, usually by 1. Control then passes to a block 528 that tests to determine if the off pulses counter is greater than or equal to the preset number of off pulses. If the test of the block 528 is not true, the control will pass by the No branch to the block 520 and the routine will proceed as described before. If the testing by the block 528 is true, control will pass by the Yes branch to a block 530 that sets the pulse flag to off, resets the on pulses counter and the off pulses counter each to 0 and then passes control to the block 520 where the routine will proceed as described above.

Referring to FIG. 7 and to FIGS. 7A, 7B, and 7C, a circuit 600 that will execute the above program will be briefly illustrated. The circuit 600 has three main components, an input/output module 602, a microprocessor module 604, and a power module 606. The power module 606 is connected to electrically by connectors 202 and 204 to the battery 608 that powers the accessories on the boat. The power module 606 is also connected electrically to the electromagnet coil 314. The reset switch 208 is connected to the microprocessor module 604 and the off/on switch 206 is connected to the power module 606. The power module 606 provides a constant filtered low voltage 610 to both the microprocessor module 604 and the input/output module 602. The power module 606 is connected to the microprocessor module to provide a drive input 612 to the power module 606. The off/on switch 206 in the on position overrides the drive input 612 from the microprocessor module 604 to the power module 606 and prevents power from reaching the coil 314. The microprocessor module 604 and the input/output modules 602 are also connected to each other to provide parallel serial load data 614 and clock data 616 to the input/output module 602 and to provide 24 bit serial data 618 from the input/output module 602 to the microprocessor module 604. The overall operation of the circuit will be discussed but the specific details of the circuit are well within the skill of those of skill in the art and will not be fully discussed.

FIG. 7A shows a detailed view of one embodiment of a circuit to power the chain cleaning device of the present invention. The drive input 612 is connected to a conventional optically coupled integrated circuit 640. The optically coupled integrated circuit 640 isolates the control circuit from the power circuit electrically connected to the coil 314 through connectors 210. The optically coupled integrated circuit 640 enable the control signals to be converted into pulses to power the coil 314. The optically coupled integrated circuit 640 is connected to and controls a conventional switching circuit using for example a MOSFET 642 or similar device to switch the 12 volt power on and off to control the coil 314. This control is in direct response to the signals received by the optically coupled integrated circuit 640 via the drive input 612.

FIG. 7B shows a detailed circuit of one embodiment of an input/output module to enable the changing of values for the chain cleaning device of the present invention. Each of the input switches 220, 222, 224, 226, 230, and 232 are connected to a series of high speed logic shift registers in a known fashion. This structure enable the user to change the values of various parameters using the input switches 220, 222, 224, 226, 230, and 232. The parallel serial load 614 is connected to pin 8 of a microprocessor 644 as shown in more detail in FIG. 7C. In a similar manner the serial data in 618 is connected to pin 7 of the microprocessor 644 and the clock serial data is connected to pin 11 of the microprocessor 644.

FIG. 7C shows a detailed circuit of the microprocessor module. The reset switch 208 is connected to a reset integrated circuit 646, the output of which is connected to pin 4 of the microprocessor 644 to clear the memory. The output 612 of the microprocessor 644 at pin 9, which operates in pulse width modulation mode, is connected to the cathode of the optically coupled integrated circuit 640 in the power module via drive input 612. The off/on switch 228 enables the multiplication of the time value by 10.

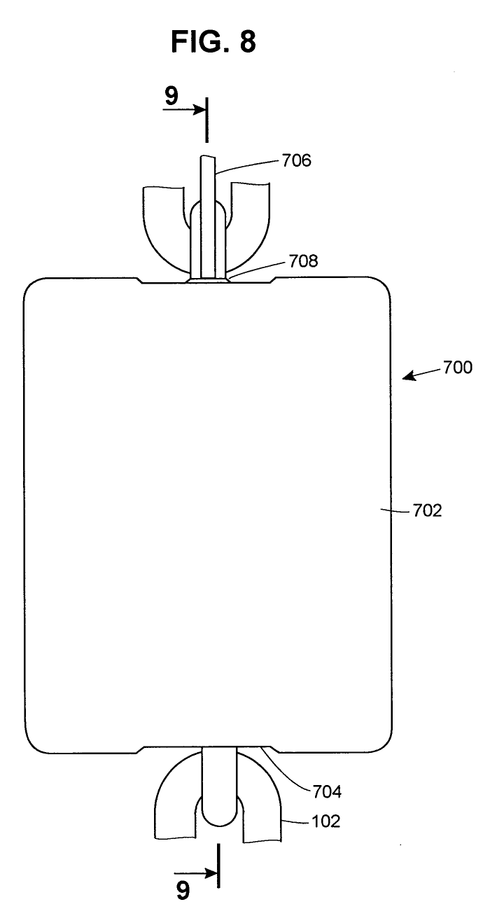

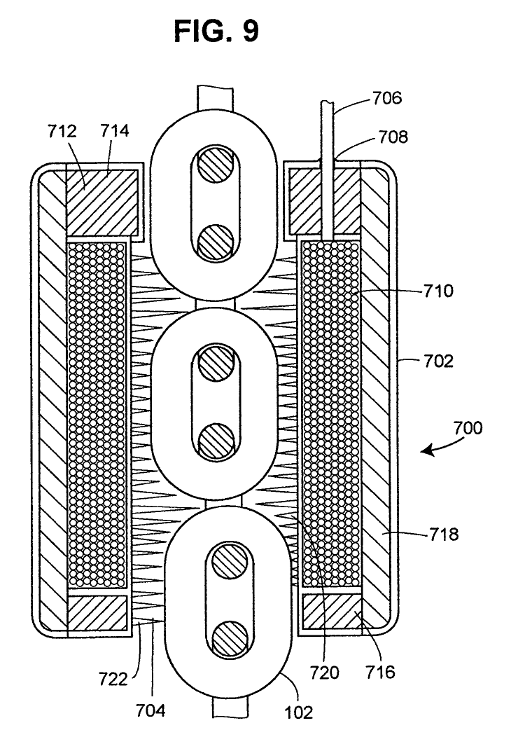

FIGS. 8 and 9 show an exterior view and a cross-sectional view of an alternative embodiment 700 of the chain cleaning device of the present invention. The chain cleaning device 700 has an exterior housing 702 and a central passage 704 that is similar to passage 302 described previously. The chain cleaning device 700 also is connected to a cable 706 which is enters the housing 702 at an aperture 708. The cable 706 is electrically connected to a coil 710. The coil 710 is formed in a manner similar to the coil 314. The coil 710 is surrounded by a body 712 having a proximal portion 714, a distal portion 716 and side portion 718. The central passage 704 is lined with a thin stainless steel sleeve 720. A series of bristles 722 are attached to the sleeve 720. The bristles can be similar to the cleaning elements 330 as described above and can either be friction fit within the sleeve 720 or held in place by conventional attachment systems well known to those of skill within the art. The chain cleaning device 700 must be manually guided over the bow roller 106 as the anchor 104 is either raised or lowered.

FIG. 10 shows a further embodiment of a control unit 800 for the chain cleaning device of the present invention. The control unit 800 includes a housing 802 that has a front surface 804. Disposed on the front surface 804 are a series of waterproof buttons 806 that can be used to specify certain parameters of the chain cleaning device. For example, as shown in FIG. 10 each parameter can have three buttons associated with that parameter, high, medium and low. Each of these buttons will have a factory preset value for the delay, pulse rate, magnet on time and time out. It is possible that some or all of these parameters can be invariably fixed at the factory or are set in a manner that can only be varied by a skilled technician who can service the control unit. The front surface 804 can also have a reset button 808 that operates in a manner similar to reset button 208 described previously. The housing will also have connections 810 for the 12 volt power source from the boats accessory system, a connection 812 that can be connected by wires 816 to the anchor windlass motor 818 to drive a switch internal to the control unit to switch on the chain cleaning device in conjunction with the operation of the windlass motor 818. Lastly, the housing will have a connection 814 from the circuitry within the housing the to the coil within the chain cleaning device.

### Industrial Applicability

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications, which come within the scope of the appended claims, are reserved.

1. A device for removing debris from a chain comprising:
a control circuit;
a housing defining an aperture passing through the housing, the aperture having a size such that a chain can pass through the housing;
an electromagnet located within the housing electrically connected to the control circuit; and
a cleaning medium within the housing in proximity to the aperture,
wherein the control circuit can energize the electromagnet in a series of discrete pulses to assist the cleaning medium in removing debris from the chain.

2. The device of claim 1 wherein the cleaning medium includes bristles.

3. The device of claim 2 wherein the bristles are thermoplastic.

4. The device of claim 3 wherein the bristles are nylon, polypropylene or polyethylene.

5. The device of claim 1 further including a cable attached to a fitting to maintain the device at a specific depth under the water and to provide power to the electromagnet.

6. The device of claim 1 wherein the housing includes a material that is capable of extending the magnet flux.

7. The device of claim 1 wherein the material is a ferrous metal.

8. The device of claim 1 wherein the control circuit includes a circuit to switch off the electromagnet after the passage of a predetermined time period.

9. The device of claim 1 wherein the device further includes a spring biased pin that engages the chain when the chain is being lowed

10. The device of claim 1 wherein the control circuit includes a circuit to delay energizing the electromagnet for a specified time period after the device has been actuated.

11. A method for the removal of debris from a chain comprising the steps of:
passing the chain through a housing wherein the housing includes an electromagnet and a cleaning medium;
energizing the electromagnet in a pulsed fashion as the chain passes through the housing; and
contacting the chain with the cleaning medium.

12. The method of claim 11 wherein the cleaning medium includes bristles

13. The method of claim 12 wherein the bristles are thermoplastic.

14. The method of claim 13 wherein the bristles are nylon, polypropylene or polyethylene.

15. The method of claim 11 wherein the method includes the additional step of maintaining the housing at a specified depth under the water while the anchor is deployed.

16. The method of claim 11 wherein the energizing step is delayed for a specified period of time after the passing step is started.

17. The method of claim 11 wherein the energizing step is stopped after a specified period of time after the passing step is started
